(19) United States
(12) Patent Application Publication
(10) Pub. No.: US 2026/0149370 A1
(43) Pub. Date: May 28, 2026

(54) CAPACITOR VOLTAGE BALANCING FOR MULTI-LEVEL LLC RESONANT CONVERTER

(71) Applicants: LITE-ON SINGAPORE PTE. LTD., Singapore (SG); Nanyang Technological University, Singapore (SG)

(72) Inventors: Zhigang YAO, Singapore (SG); Yi TANG, Singapore (SG); Ziheng XIAO, Singapore (SG); Lei ZHANG, Singapore (SG); Fei DENG, Singapore (SG); Jing YANG, Singapore (SG); Shih-Ming CHEN, Taipei (SG); Yi Chyn Cassandra WONG, Singapore (SG)

(21) Appl. No.: 19/228,951

(22) Filed: Jun. 5, 2025

Related U.S. Application Data
(60) Provisional application No. 63/724,506, filed on Nov. 25, 2024.

(51) Int. Cl. H02M 3/00; H02M 1/00; H02M 3/335

(52) U.S. Cl. CPC H02M 3/015; H02M 1/0095; H02M 3/33573

(57) ABSTRACT

In an aspect of the disclosure, an operation method, for balancing voltage of capacitors of a bridge circuit of a multi-level LLC resonant converter, includes: measuring voltages of the capacitors of the bridge circuit, an output voltage and an output current of an output load the multi-level LLC resonant converter, and an input voltage of the bridge circuit; selecting a voltage-level zone of a required output voltage of the bridge circuit according to the output voltage of the output load, and the input voltage of the bridge circuit; selecting a circuit mode, with a highest value of the required output voltage; and outputting PWM signals corresponding to the circuit mode, with a switching frequency, to switches of the plurality of capacitor-switch modules.

This application claims the benefit of U.S. provisional application Ser. No. 63/724,506, filed Nov. 25, 2024, the subject matter of which is incorporated herein by reference.

### TECHNICAL FIELD

The disclosure relates in general to a multi-level LLC resonant converter, and more particularly, to techniques of methods and apparatuses for balancing capacitor voltage of bridge circuit of multi-level LLC resonant converter.

### BACKGROUND

The growing demand for medium and high-voltage applications in industries, such as renewable energy systems, electric vehicle charging stations, photovoltaic (PV) generation, and industrial power supplies, has driven the development of multi-level LLC resonant converters. However, multi-level LLC resonant converters with various multilevel topologies, bring added complexity for managing the voltage balancing of multiple flying or series capacitors within the bridge circuit or switch network of the converter. These capacitors are critical to the operation of the multi-level converter, and ensuring that their voltages remain balanced is essential for maintaining proper converter functionality. Imbalanced capacitor voltages can lead to uneven voltage stress across the power switches, resulting in suboptimal performance, reduced efficiency, and potentially damaging the devices. Thus, there are needs for techniques of balancing capacitor voltages of multi-level LLC resonant converter without variable duty cycles or phase shifts.

### SUMMARY

The present disclosure describes techniques for application of balancing capacitor voltages of bridge circuit (or switch network) of multi-level LLC resonant converter while maintaining a constant 50% duty cycle without the need for variable duty cycles or phase shifts.

The first aspect of the present disclosure features a multi-level LLC resonant converter. The multi-level LLC resonant converter includes a bridge circuit including multiple capacitor-switch modules. The multi-level LLC resonant converter also includes a LLC resonant tank coupled to the bridge circuit. The multi-level LLC resonant converter also includes a rectifier circuit coupled to the LLC resonant tank and including an output load. The multi-level LLC resonant converter also includes a controller coupled to the plurality of capacitor-switch modules and configured to measure voltages of capacitors of the multiple capacitor-switch modules, an output voltage and an output current of the output load, and an input voltage of the bridge circuit. To balance the voltages of the capacitors, the controller executes operations of: selecting, according to the output voltage of the output load and the input voltage of the bridge circuit, a voltage-level zone of a required output voltage of the bridge circuit from a number of voltage-level zones corresponding to a number of the capacitors; selecting a circuit mode, with a highest value of the required output voltage of the bridge circuit, from at least one circuit mode corresponding to the voltage-level zone, wherein the highest value of the required output voltage is corresponding values of the voltages of the capacitors; and outputting PWM signals corresponding to the circuit mode, with a switching frequency, to switches of the plurality of capacitor-switch modules.

The second aspect of the present disclosure features an operation method for balancing voltage of capacitors of a bridge circuit of a multi-level LLC resonant converter. The operation method includes measuring, by a controller of the multi-level LLC resonant converter, the voltages of the capacitors of multiple capacitor-switch modules of the bridge circuit, an output voltage and an output current of an output load of a rectifier circuit of the multi-level LLC resonant converter, and an input voltage of the bridge circuit. The operation method also includes selecting, by the controller, a voltage-level zone of a required output voltage of the bridge circuit from a number of voltage-level zones corresponding to a number of the capacitors, according to the output voltage of the output load, and the input voltage of the bridge circuit. The operation method also includes selecting, by the controller, a circuit mode, with a highest value of the required output voltage of the bridge circuit, from at least one circuit mode corresponding to the voltage-level zone, wherein the highest value of the required output voltage is corresponding values of the voltages of the capacitors. The operation method also includes outputting PWM signals corresponding to the circuit mode, with a switching frequency, to switches of the plurality of capacitor-switch modules.

The details of one or more disclosed implementations are set forth in the accompanying drawings and the description below. Other features, aspects, and advantages will become apparent from the description, the drawings and the claims.

### BRIEF DESCRIPTION OF THE DRAWINGS

FIG. 1 is a block diagram illustrating a multi-level LLC resonant converter, according to some implementations of the present disclosure.

FIG. 2 is a flowchart illustrating a process for balancing voltages of capacitors of a bridge circuit of a multi-level LLC resonant converter, according to some implementations of the present disclosure.

FIG. 3 is a diagram illustrating a five-level LLC resonant converter including a controller, according to some implementations of the present disclosure.

FIG. 4A is a waveform diagram illustrating unbalanced voltage of the five-level LLC resonant converter in FIG. 3, according to some implementations of the present disclosure.

FIG. 4B is a waveform diagram illustrating balanced voltage of the five-level LLC resonant converter in FIG. 3, according to some implementations of the present disclosure.

FIG. 5 is a comparison diagram illustrating waveform diagrams as results of the conventional technique and technique provided by the present disclosure, for balancing capacitor voltages of multi-level LLC resonant converter.

FIG. 6A is a diagram illustrating a midpoint diode clamped five-level LLC resonant converter including a controller, according to some implementations of the present disclosure.

FIG. 6B is a diagram illustrating a flying-capacitor five-level LLC resonant converter including a controller, according to some implementations of the present disclosure.

FIG. 6C is a diagram illustrating a flying-capacitor three-level LLC resonant converter including a controller, according to some implementations of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

The terms “comprise,” “comprising,” “include,” “including,” “has,” “having,” etc. used in this specification are open-ended and mean “comprises but not limited.” The terms used in this specification generally have their ordinary meanings in the art and in the specific context where each term is used. The use of examples in this specification, including examples of any terms discussed herein, is illustrative only, and in no way limits the scope and meaning of the disclosure or of any exemplified term. Likewise, the present disclosure is not limited to various embodiments given in this specification.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative embodiments but, like the illustrative embodiments, should not be used to limit the present disclosure. The elements included in the illustrations herein may not be drawn to scale.

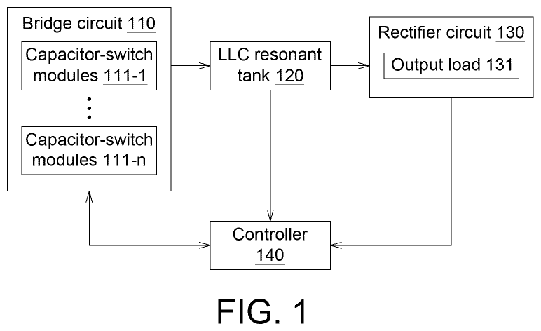

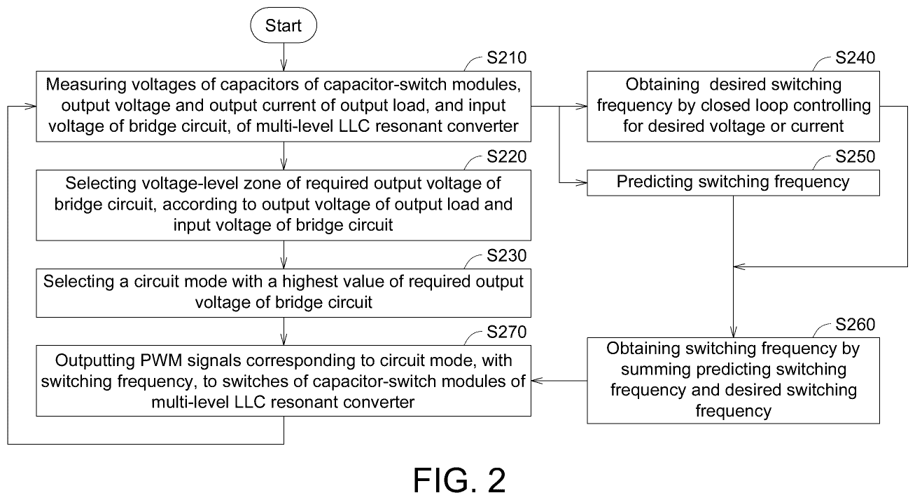

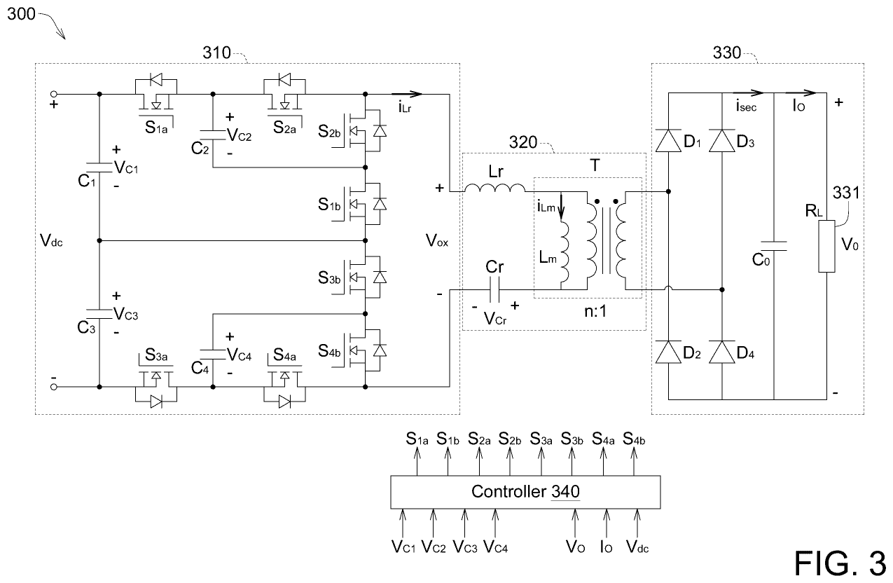

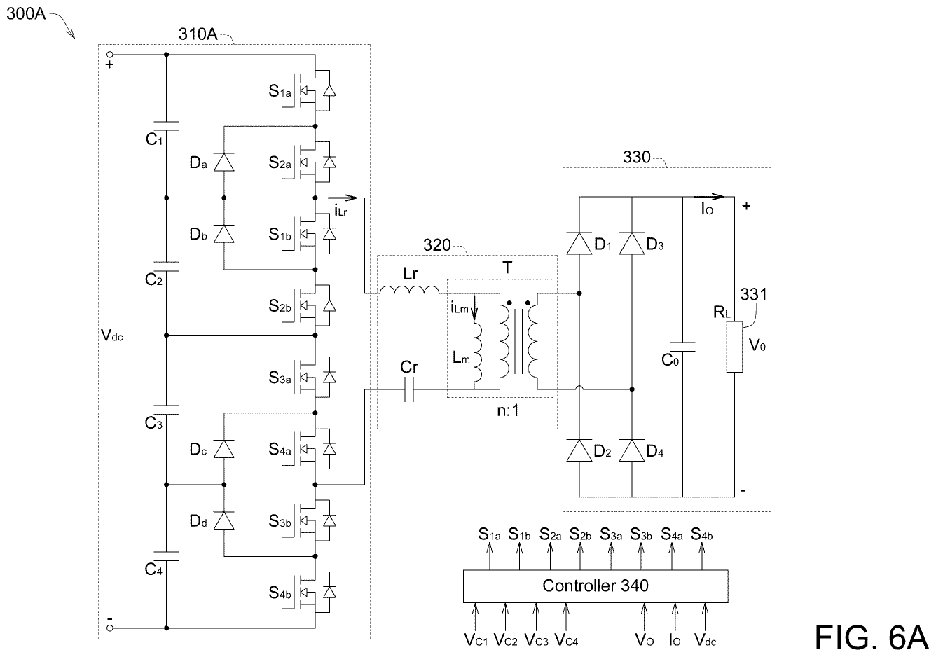

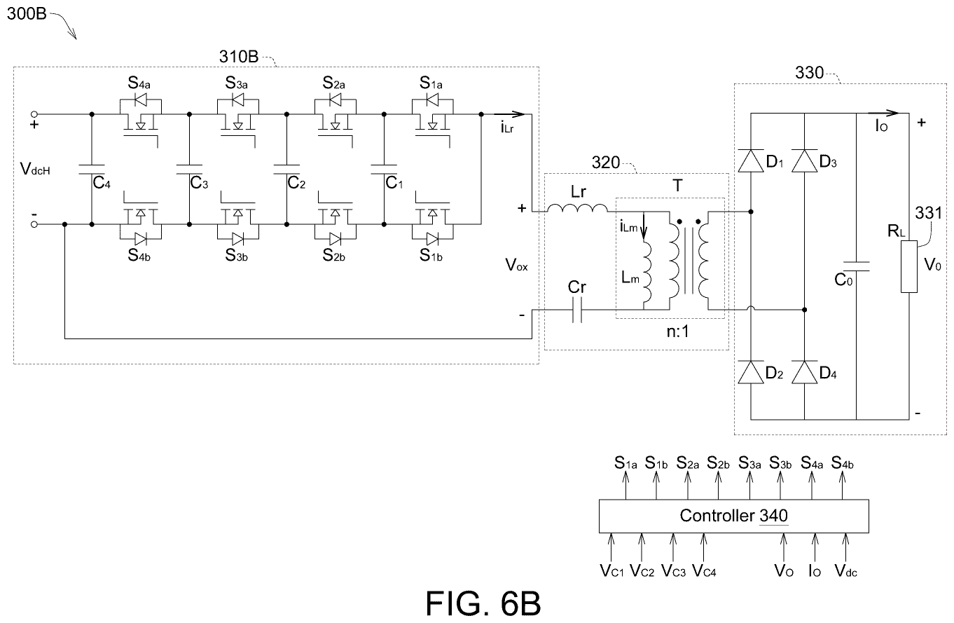

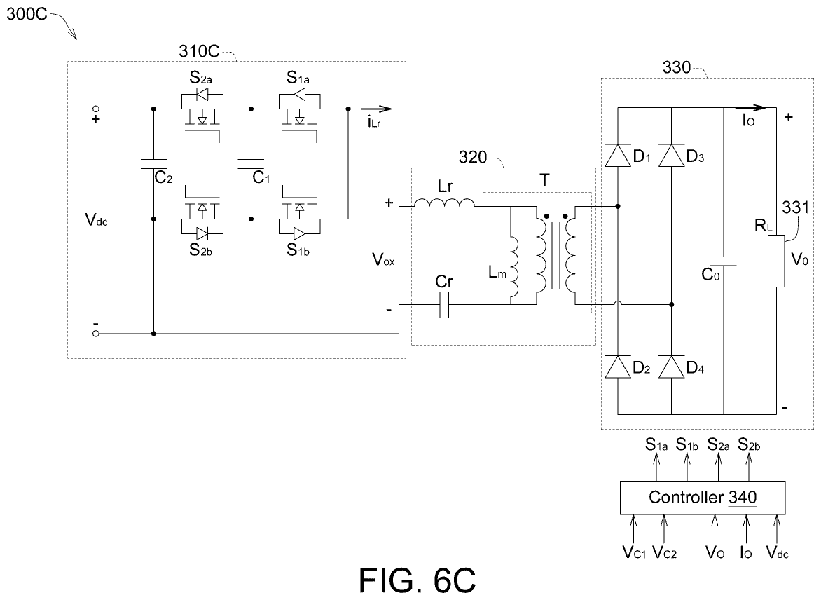

FIG. 1 is a block diagram illustrating a multi-level LLC resonant converter 100, according to some implementations of the present disclosure. The multi-level LLC resonant converter 100 includes a bridge circuit 110. The bridge circuit 110 includes capacitor-switch modules, 111-1 to 111-n, depending on demands of levels and structures for the LLC resonant converter. Each of capacitor-switch modules, 111-1 to 111-n, may include a complementary pair of switches (such as S₁ₐ and S_{1b}, S₂ₐ and S_{2b}, S₃ₐ and S_{3b}, or S₄ₐ and S_{4b} in FIG. 3 and FIGS. 6A-6C) and one capacitor (such as C₁-C₄ in FIG. 3 and FIGS. 6A-6C). The multi-level LLC resonant converter 100 also includes a LLC resonant tank 120 coupled to the bridge circuit 110. The LLC resonant tank 120 may include a resonant capacitor (such as Cᵣ in FIG. 3 and FIGS. 6A-6C), a resonant inductor (such as Lᵣ in FIG. 3 and FIGS. 6A-6C) and a transformer (such as T in FIG. 3 and FIGS. 6A-6C) including a magnetizing inductor (such as Lₘ in FIG. 3 and FIGS. 6A-6C). The transformer includes a turn ratio (such as n in FIG. 3 and FIGS. 6A-6C). The multi-level LLC resonant converter 100 also includes a rectifier circuit 130 coupled to the LLC resonant tank 120. The rectifier circuit 130 may include multiple diodes (such as D₁-D4 in FIG. 3 and FIGS. 6A-6C), an output capacitor (such as Cₒ in FIG. 3 and FIGS. 6A-6C), and an output load 131. The output load 131 is with a resistance (such as R_{L} in FIG. 3 and FIGS. 6A-6C), an output voltage (such as Vₒ in FIG. 3 and FIGS. 6A-6C) and an output current (such as Iₒ in FIG. 3 and FIGS. 6A-6C). The multi-level LLC resonant converter 100 also includes a controller 140 coupled to capacitor-switch modules, 111-1 to 111-n, and configured to measure voltages (such as V_{C1}-V_{C4} in FIG. 3 and FIGS. 6A-6C) of capacitors (such as C₁-C₄ in FIG. 3 and FIGS. 6A-6C) of the multiple capacitor-switch modules, 111-1 to 111-n, an output voltage and an output current of the output load (such as Vₒ and Iₒ in FIG. 3 and FIGS. 6A-6C), and an input voltage of the bridge circuit (such as V_{dc} in FIGS. 3-4B and FIGS. 6A-6C). The controller 340 may be implemented by using a DSP or FPGA controller. For balancing the voltages of the capacitors, the process operate by the controller will be described in detail referred with FIGS. 2 and 3 as follows.

FIG. 2 is a flowchart illustrating a process for balancing voltages of capacitors of a bridge circuit of a multi-level LLC resonant converter, and FIG. 3 is a diagram illustrating a five-level LLC resonant converter 300 including a controller 340, according to some implementations of the present disclosure. The following description of a multi-level LLC resonant converter for operating the process in FIG. 2 takes the five-level LLC resonant converter 300 including the controller 340 in FIG. 3 as an example, but not limited thereto. Regarding the five-level LLC resonant converter 300, the bridge circuit 310 (also referred as capacitor-switch modules) includes two serial-connected capacitor-switch modules (the upper part and the lower part of the bridge circuit 310), and each of the two serial-connected capacitor-switch modules includes a complementary pair of switches, as main switches and their complementary switches, and one capacitor, wherein the main switches are S₁ₐ, S₂ₐ, S₃ₐ and S₄ₐ, and their complementary switches are S_{1b}, S_{2b}, S_{3b} and S_{4b}, respectively. A gate of each switch (each of switches S₁ₐ to S_{4b}) of the four capacitor-switch modules is coupled to the controller 340 to receive the PWM signals to balance voltages of the flying capacitors (C₁ to C₄) of the four capacitor-switch modules, as shown in FIG. 3. Referring to FIGS. 2 and 3, in step S210, according to a desired voltage or current reference (such as predetermined by external configuration, such as input by a communication, or by internal configuration, such as preset desired voltage or current reference), the controller 300 measures the voltages (V_{C1}-V_{C4}) of the capacitors (C₁-C₄) of multiple capacitor-switch modules (S₁ₐ, S_{1b} and C₁, S₂ₐ, S_{2b} and C₂, S₃ₐ, S_{3b} and C₃, and S₄ₐ,S_{4b} and C₄) of the bridge circuit 310, the output voltage Vₒ, and the output current Iₒ of the output load 331 of the rectifier circuit 330, and the input voltage V_{dc} of the bridge circuit 310.

In step S220, the controller 340 selects a voltage-level zone of a required output voltage Vₒₓ of the bridge circuit 310 from 5 voltage-level zones according to the output voltage Vₒ, and the input voltage V_{dc}. Due to the multi-level (m-level) LLC resonant converter in this example is a “five-level” (m=5) LLC resonant converter 300, there are 5 voltage-level zones from level 1 to level 5 (m voltage-level zones from level 1 to level m), and m voltage-level zones is corresponding to (m−1) capacitors, such as 5 voltage-level zones is corresponding to 4 capacitors (C₁, C₂, C₃ and C₄) in this example.

Specifically, the controller 340 calculates the voltage-level zone x of the required output voltage Vₒₓ by an equation of:

$$x = round ( \frac{( m - 1 ) * 2 n * {V}_{o}}{{V}_{d c}} )$$

Wherein, n represents a turn ratio of the transformer T, and round ( ) represents a rounding function to obtain x as an integer. After obtaining x, the controller 340 matches x to level (x+1) of the level 1 to the level m, as shown by the right column (Vₒₓ at balanced capacitor voltages) in the Table I below.

TABLE I
Circuit mode i of five-level LLC resonant converter 300.

| | | | Vₒₓ at |
|---|---|---|---|
| | | | balanced |
| Circuit | S₄ₐ, S₃ₐ, | | capacitor |
| mode i | S₂ₐ, S₁ₐ | Vₒₓ | voltages |
| 0 | 0, 0, 0, 0 | 0 | 0, x = 0 |
| | | | (level 1) |
| 1 | 0, 0, 0, 1 | V_{C1} − V_{C2} | V_{dc}/4, x = 1 |
| 2 | 0, 0, 1, 0 | V_{C2} | (level 2) |
| 3 | 0, 1, 0, 0 | V_{C3} − V_{C4} | |
| 4 | 1, 0, 0, 0 | V_{C4} | |
| 5 | 0, 0, 1, 1 | V_{C1} | V_{dc}/2, x = 2 |
| 6 | 0, 1, 0, 1 | V_{C1} − V_{C2} + V_{C3} − V_{C4} | (level 3) |
| 7 | 1, 0, 0, 1 | V_{C1} − V_{C2} + V_{C4} | |
| 8 | 0, 1, 1, 0 | V_{C2} + V_{C3} − V_{C4} | |
| 9 | 1, 0, 1, 0 | V_{C4} + V_{C2} | |
| 10 | 1, 1, 0, 0 | V_{C3} | |
| 11 | 0, 1, 1, 1 | V_{C1} + V_{C3} − V_{C4} | 3V_{dc}/4, x = 3 |
| 12 | 1, 0, 1, 1 | V_{C1} + V_{C4} | (level 4) |
| 13 | 1, 1, 0, 1 | V_{C1} − V_{C2} + V_{C3} | |
| 14 | 1, 1, 1, 0 | V_{C2} + V_{C3} | |
| 15 | 1, 1, 1, 1 | V_{C1} + V_{C3} | V_{dc}, X = 4 |
| | | | (level 5) |

In step S230, after selecting the voltage-level zone x, the controller 340 selects a circuit mode i, with a highest value of the required output voltage Vₒₓ of the bridge circuit 310, from circuit modes (such as circuit modes 0-15 in Table I) corresponding to the voltage-level zone (such as X=0 to X=4 in Table I). The highest value of the required output voltage Vₒₓ is corresponding values of the voltages (V_{C1}-V_{C4}) of the capacitors (C₁-C₄). For the five-level LLC resonant converter 300, the output circuit mode I can be divided into 16 (such as (m−1)²) types, as shown in Table I. When the four capacitor voltages (V_{C1}-V_{C4}) are balanced, such as V_{C1}=V_{C3}=V_{dc}/2, V_{C2}=V_{C4}=V_{dc}/4, the output voltages Vₒₓ of 16 types of circuit modes can be classified into these voltage levels: 0 (level 1), V_{dc}/4 (level 2), V_{dc}/2 (level 3), 3V_{dc}/4 (level 4), V_{dc} (level 5), as shown in Table I. For example, if x=1, the output voltages Vₒₓ(V_{C1}-V_{C2} in current mode 1, V_{C2} in current mode 2, V_{C3}-V_{C4} in current mode 3, and V_{C4} in current mode 5) of all current modes (as current modes 1-4) corresponding to the level 2 (x=1) are calculated. After calculating the output voltages Vₒₓ, for example, if the output voltage Vₒₓ(V_{C1}-V_{C2}) in current mode 1 is with the highest value comparing to other output voltages Vₒₓ, the circuit mode 1 is selected.

In step S240, after selecting the current mode I (selecting current mode 1 for example), the controller 340 outputs PWM signals corresponding to the circuit mode (such as PWM signals 0, 0, 0, 1 corresponding to the circuit mode 1), with a switching frequency f_{sw}, to switches (such as S₄ₐ, S₃ₐ, S₂ₐ, S₁ₐ), such that the corresponding capacitor is discharged to reduce the capacitor voltage. The switching frequency f_{sw} can be obtained by steps S240, S250 and S260.

In step S260, the switching frequency f_{sw} is obtained by summing a predicted switching frequency F_{sw} (by step S250) and a desired switching frequency Δf_{sw} obtained by using closed-loop control of the controller for the desired voltage or current (by step S240). Specifically, in step S250, according to the difference between desired output voltage reference and the output voltage Vₒ, the desired switching frequency Δf_{sw} (the difference between the predicted switching frequency F_{sw} and the switching frequency f_{sw}) can be obtained by comparing the gain-frequency curve. Specifically, in step S240, the predicted switching frequency F_{sw} can be obtained according to the required output voltage value Vₒₓ of the selected circuit mode i and the output voltage Vₒ and output current Iₒ of the output load such as by the equation of:

$$\frac{{V}_{o}}{{V}_{o x}} = ( \frac{0.5}{\sqrt{{( 1 + \frac{1}{k} ( 1 - \frac{1}{{f}_{n}^{2}} ) )}^{2} + {{Q}^{2} ( 1 - \frac{1}{{f}_{n}} )}^{2}}} )$$

Wherein n represents the turn ratio of the transformer T, k represents inductor ratio of the resonant tank (Lₘ/Lᵣ), fₙ represents predicted switching frequency F_{sw} divided by series resonant frequency fᵣ (F_{sw}/fᵣ), wherein series resonant frequency fᵣ=1/(2π(Lᵣ−Cᵣ)^{1/2}), Q is the quality factor of the resonant converter, and Vₒₓ is the output voltage of the bridge circuit and listed in Table I.

In some implementations, the circuit mode i is changed at the circuit mode transition time, wherein the PWM signals can be maintained with a constant 50% duty cycle and variable switching frequency f_{sw}.

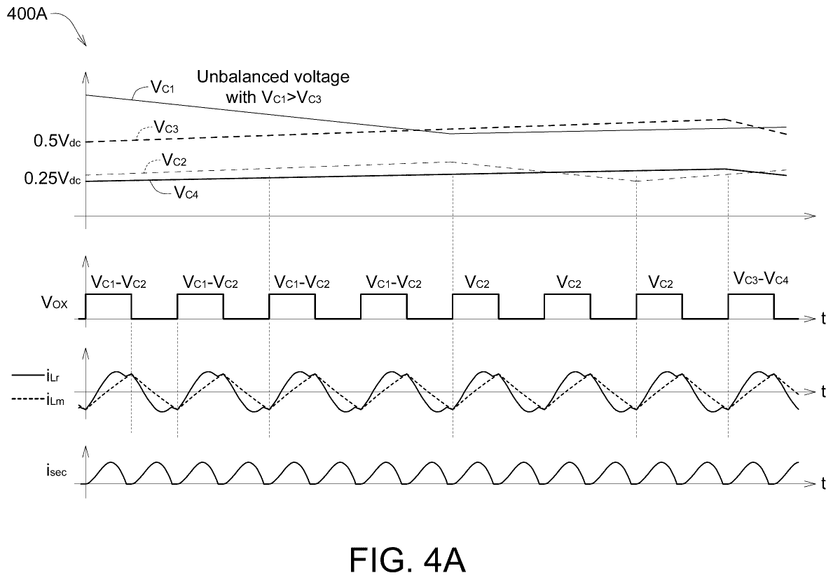

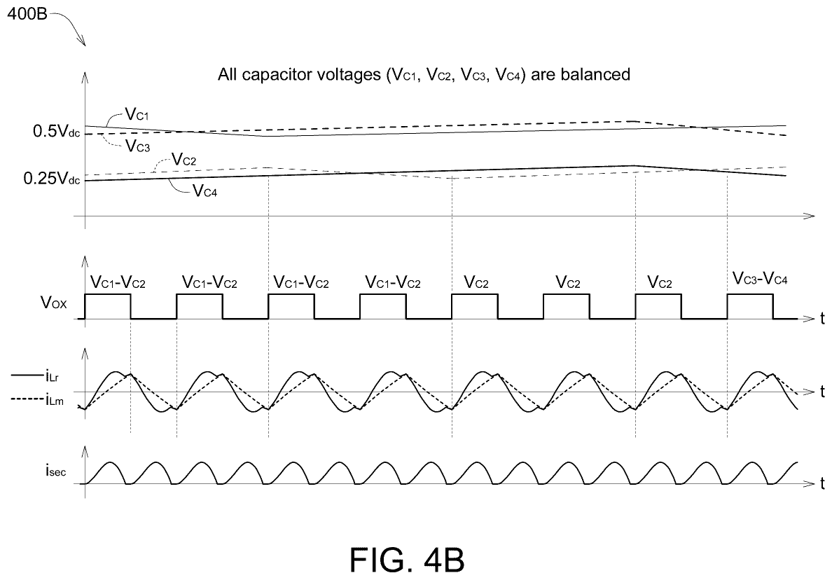

FIGS. 4A and 4B are waveform diagrams, 400A and 400B, respectively illustrating unbalanced and balanced voltage of the five-level LLC resonant converter 300 in FIG. 3, according to some implementations of the present disclosure. Referring to FIG. 4A, taking the unbalanced voltage V_{C1}>V_{C3} and voltage-level zone x=1 (as level 2 in Table I) as an example, the circuit mode i=1 will be selected according to the operation process discussed above (such as by steps s210-s230). Thus, the output voltage Vₒₓ is V_{C1}-V_{C2} for the input voltage V_{dc} of the bridge circuit. The output voltage of V_{C1}-V_{C2} is decreasing until the operation process discussed above detect circuit mode i=1 is not the highest voltage (such as by the step s230). When V_{C2} is the highest voltage in all circuit modes (such as circuit modes 1-4 in Table I) corresponding to voltage-level zone x=1 (level 2), the selected circuit mode is changed to i=2 (circuit mode 2), so that the voltage of V_{C2} will decrease until the voltage of another circuit mode at voltage-level zone x=1 (level 2) is changed to the highest. During this voltage balancing process, the duty cycle is always a constant 50%.

Referring to FIG. 4B, after all capacitor voltages (V_{C1}, V_{C2}, V_{C3}, V_{C4}) are balanced, the four capacitors ((C₁, C₂, C₃, C₄) are alternately charged and discharged until their voltages reach a balanced state. During this control process, the duty cycle is always a constant 50%, so the resonant current is a symmetrical positive and negative waveform, making it easy to realize ZVS soft-switching.

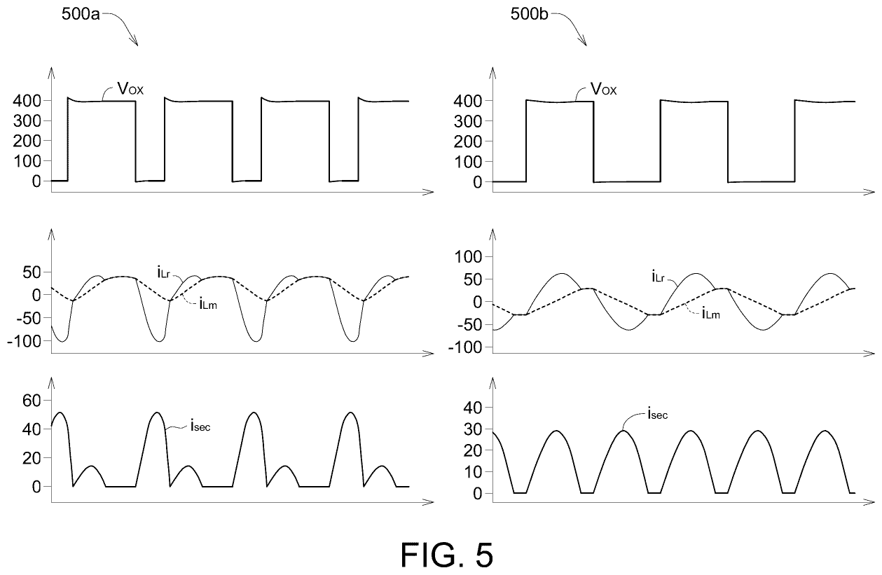

FIG. 5 is a comparison diagram illustrating waveform diagrams, 500a and 500b, as results of the conventional technique and proposed technique provided by the present disclosure, for balancing capacitor voltages of multi-level LLC resonant converter. As shown by the waveform diagram 500a, the conventional technique, such as phase shifting or variable duty cycles, causes the PWM signal to deviate from the ideal 50% duty cycle, leading to distortion in the resonant inductor current. As shown by the waveform diagram 500b, proposed technique provided by the present disclosure discharges the capacitor with the highest voltage across all same-voltage-level circuit modes, maintaining a constant 50% duty cycle without the need for variable duty cycles or phase shifts. As a result, it preserves both ZVS and the sinusoidal characteristics of the LLC resonant converter. Additionally, the predicted switching frequency ensures smooth transitions between circuit modes during voltage balancing, preventing inrush currents or voltage spikes. Comparing to the conventional technique, the technique provided by the present disclosure not only balances capacitor voltages more quickly but also maintains ZVS and the sinusoidal waveform of the LLC resonant converter by preserving a consistent 50% duty cycle.

FIG. 6A is a diagram illustrating a midpoint diode clamped five-level LLC resonant converter 300A including a controller 340, according to some implementations of the present disclosure. The bridge circuit 310A of the midpoint diode clamped five-level LLC resonant converter 300A includes two neutral-point clamped three-level topologies coupled to a LLC resonant tank 320 coupled to the rectifier circuit 330. In other words, the bridge circuit 310A includes four capacitor-switch modules with midpoint clamps and flying capacitors, and each of the four capacitor-switch modules includes a complementary pair of switches and one capacitor, wherein a gate of each switch (each of switches S₁ₐ to S_{4b}) of the four capacitor-switch modules is coupled to the controller 340 to receive the PWM signals to balance voltages of the flying capacitors (C₁ to C₄) of the four capacitor-switch modules, as shown in FIG. 6A. Similarly to the five-level LLC resonant converter 300 shown in FIG. 3, the midpoint diode clamped five-level LLC resonant converter 300A can also generate 16 types of circuit modes (0-15), which are divided into five voltage levels: 0 (level 1), V_{dc}/4 (level 2), V_{dc}/2 (level 3), 3V_{dc}/4 (level 4), V_{dc} (level 5), as shown in Table I. By applying the proposed capacitor voltage balancing process discussed above, the voltages of the four capacitors, C₁, C₂, C₃ and C₄, in FIG. 6A can be balanced to V_{dc}/4. The proposed capacitor voltage balancing process discussed above also enables the balancing of all capacitor voltages while maintaining ZVS and the near sinusoidal current benefits of the midpoint diode clamped five-level LLC resonant converter 300A with a constant 50% duty cycle.

FIG. 6B is a diagram illustrating a flying-capacitor five-level LLC resonant converter 300B including a controller 340, according to some implementations of the present disclosure. The bridge circuit 310B of flying-capacitor five-level LLC resonant converter 300B includes a flying-capacitor five-level circuit topology, coupled to a LLC resonant tank 320 coupled to the rectifier circuit 330. In other words, the bridge circuit 310B includes four serial-connected capacitor-switch modules, and each of the four serial-connected capacitor-switch modules includes a complementary pair of switches and one capacitor, wherein a gate of each switch (each of switches S₁ₐ to S_{4b}) of the four capacitor-switch modules is coupled to the controller 340 to receive the PWM signals to balance voltages of the flying capacitors (C₁ to C₄) of the four capacitor-switch modules as shown in FIG. 6B. Similarly to the five-level LLC resonant converter 300 shown in FIG. 3, the flying-capacitor five-level LLC resonant converter 300B can also 16 types of circuit modes (0-15), which are divided into five voltage levels: 0 (level 1), V_{dc}/4 (level 2), V_{dc}/2 (level 3), 3V_{dc}/4 (level 4), V_{dc} (level 5), as shown in Table I. By applying the proposed capacitor voltage balancing process discussed above, the voltages of the four capacitors, C₁, C₂, C₃ and C₄, in FIG. 6A can be balanced to V_{dc}/4, V_{dc}/2, 3V_{dc}/4 and V_{dc}, respectively. The proposed capacitor voltage balancing process discussed above also enables the balancing of all capacitor voltages while maintaining ZVS and the near sinusoidal current benefits of the flying-capacitor five-level LLC resonant converter 300B with a constant 50% duty cycle.

FIG. 6C is a diagram illustrating a flying-capacitor three-level LLC resonant converter 3000 including a controller 340C, according to some implementations of the present disclosure. Referring to Table II corresponding to the flying-capacitor three-level LLC resonant converter 3000, below, due to the multi-level (m-level) LLC resonant converter in this example is the flying-capacitor “three-level (m=3)” LLC resonant converter 3000, there are 3 voltage-level zones from level 1 to level 3 (m voltage-level zones from level 1 to level m), and m voltage-level zones is corresponding to (m−1) capacitors, such as 3 voltage-level zones is corresponding to 2 capacitors (C₁ and C₂) in this example. By applying the proposed capacitor voltage balancing process discussed above, the circuit mode i=1 can be used to discharge the capacitor C₁, and the circuit mode i=2 can be used to discharge the capacitor C₂ while charging C₁. So, if the voltage of the capacitor C is more than the desired balanced voltage V_{dc}/2, the circuit mode i=1 will be selected to discharge the capacitor C₁. Otherwise, the circuit mode i=2 will be selected to charge the capacitor C₁.

TABLE II
Circuit mode of three-level LLC resonant converter 300C.

| Circuit | | | Vₒₓ at balanced |
|---|---|---|---|
| mode i | S₂ₐ, S₁ₐ | Vₒₓ | capacitor voltages |
| 0 | 0, 0, | 0 | 0, x = 0 (level 1) |
| 1 | 0, 1 | V_{C1} | V_{dc}/2, x = 1 (level 2) |
| 2 | 1, 0, | V_{C2}− V_{C1} | |
| 3 | 1, 1 | V_{C1} + V_{C2} | V_{dc}, x = 2 (level 3) |

As descriptions regarding different topologies of multi-level LLC resonant converter, the proposed capacitor voltage balancing process can also be extended to all multi-level (for example, more than five-level topology or less than five-level topology) LLC resonant converters. The key step is to identify the circuit mode corresponding to the highest capacitor voltage by calculating the voltages of all modes in the level zone x. Once identified, the circuit topology is reconfigured to operate in mode i within the LLC converter, allowing the capacitor in this mode to discharge. As the voltage of circuit mode i decreases and another mode reaches the highest voltage, the topology is reshaped again to match the new highest-voltage mode. This process continues until all capacitor voltages are balanced at the desired levels.

Accordingly, the techniques provided by implementations of the present disclosure are not limited to a single circuit topology, but can be applied to various multi-level LLC resonant converters. These topologies are widely used in medium- and high-voltage applications requiring DC-to-DC power conversion, such as renewable energy systems, electric vehicle charging stations, photovoltaic (PV) generation, and industrial power supplies. By implementing the techniques provided by implementations of the present disclosure, various multi-level LLC resonant converters can balance all capacitor voltages while maintaining ZVS and the near sinusoidal current benefits of the LLC resonant converter with a constant 50% duty cycle.

The processes and logic flows described in this document can be performed by one or more programmable processors executing one or more computer programs to perform the functions described herein. The processes and logic flows can also be performed by, and apparatus can also be implemented as, special purpose logic circuitry, e.g., an FPGA (field programmable gate array) or an ASIC (application specific integrated circuit).

While this document may describe many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination in some cases can be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is:

1. A multi-level LLC resonant converter, comprising:
a bridge circuit, including a plurality of capacitor-switch modules;
a LLC resonant tank, coupled to the bridge circuit and including a transformer;
a rectifier circuit, coupled to the LLC resonant tank and including an output load; and
a controller, coupled to the plurality of capacitor-switch modules and configured to measure voltages of capacitors of the plurality of capacitor-switch modules, an output voltage and an output current of the output load, and an input voltage of the bridge circuit,
wherein, to balance the voltages of the capacitors, the controller executes operations of:
selecting, according to the output voltage of the output load and the input voltage of the bridge circuit, a voltage-level zone of a required output voltage of the bridge circuit from a number of voltage-level zones corresponding to a number of the capacitors;
selecting a circuit mode, with a highest value of the required output voltage of the bridge circuit, from at least one circuit mode corresponding to the voltage-level zone, wherein the highest value of the required output voltage is corresponding values of the voltages of the capacitors; and
outputting PWM signals corresponding to the circuit mode, with a switching frequency, to switches of the plurality of capacitor-switch modules.

2. The multi-level LLC resonant converter of claim 1,
wherein the multi-level LLC resonant converter is an m-level LLC resonant converter including m voltage-level zones from level 1 to level m, wherein m is an integer larger or equal to 3,
wherein the controller selecting the voltage-level zone from the level 1 to the level m is determined by
$$x = round ( \frac{( m - 1 ) * 2 n * {V}_{o}}{{V}_{d c}} ) ,$$
and matching x to level (x+1) of the level 1 to the level m, wherein V_{dc} representing the input voltage of the bridge circuit, Vₒ representing the output voltage of the output load, n representing a turn ratio of the transformer, and round ( ) representing a rounding function to obtain x as an integer.

3. The multi-level LLC resonant converter of claim 2, wherein the required output voltages of the bridge circuit in the level 1 to level m are corresponding to different ratios of the input voltage of the bridge circuit.

4. The multi-level LLC resonant converter of claim 2, wherein the at least one circuit mode includes 2^{(m-1)} circuit modes,
wherein the PWM signals, for switches, between each of the at least one circuit mode are different, and each of the at least one circuit mode corresponding to a value of the required output voltage.

5. The multi-level LLC resonant converter of claim 1, wherein the switching frequency is obtained by the controller according to a turn ratio of the transformer, an inductor ratio and a resonant frequency of the LLC resonant tank, the output voltage of the output load, the required output voltage of the bridge circuit, and a quality factor.

6. The multi-level LLC resonant converter of claim 1, wherein the plurality of capacitor-switch modules include four serial-connected capacitor-switch modules, and each of the four serial-connected capacitor-switch modules includes a complementary pair of switches and one capacitor,
wherein a gate of each switch of the four serial-connected capacitor-switch modules is coupled to the controller to receive the PWM signals to balance voltages of the capacitors of the two serial-connected capacitor-switch modules.

7. The multi-level LLC resonant converter of claim 1, wherein the plurality of capacitor-switch modules include two serial-connected capacitor-switch modules, and each of the two serial-connected capacitor-switch modules includes a complementary pair of switches and one capacitor,
wherein a gate of each switch of the two serial-connected capacitor-switch modules is coupled to the controller to receive the PMW signals to balance voltages of the capacitors of the two serial-connected capacitor-switch modules.

8. The multi-level LLC resonant converter of claim 1, wherein the plurality of capacitor-switch modules include four capacitor-switch modules with midpoint clamps and flying capacitors, and each of the four capacitor-switch modules includes a complementary pair of switches and one capacitor,
wherein a gate of each switch of the four capacitor-switch modules is coupled to the controller to receive the PWM signals to balance voltages of the flying capacitors of the four capacitor-switch modules.

9. An operation method, for balancing voltage of capacitors of a bridge circuit of a multi-level LLC resonant converter, the operation method comprising:
measuring, by a controller of the multi-level LLC resonant converter, the voltages of the capacitors of a plurality of capacitor-switch modules of the bridge circuit, an output voltage and an output current of an output load of a rectifier circuit of the multi-level LLC resonant converter, and an input voltage of the bridge circuit;
selecting, by the controller, a voltage-level zone of a required output voltage of the bridge circuit from a number of voltage-level zones corresponding to a number of the capacitors, according to the output voltage of the output load, and the input voltage of the bridge circuit;
selecting, by the controller, a circuit mode, with a highest value of the required output voltage of the bridge circuit, from at least one circuit mode corresponding to the voltage-level zone, wherein the highest value of the required output voltage is corresponding values of the voltages of the capacitors; and
outputting PWM signals corresponding to the circuit mode, with a switching frequency, to switches of the plurality of capacitor-switch modules.

10. The operation method of claim 9, wherein the multi-level LLC resonant converter is an m-level LLC resonant converter including n voltage-level zones from level 1 to level m, wherein m is an integer larger or equal to 3,
wherein the controller selecting the voltage-level zone from the level 1 to the level m is determined by
$$x = round ( \frac{( m - 1 ) * 2 n * {V}_{o}}{{V}_{d c}} ) ,$$
and matching x to level (x+1) of the level 1 to the level m, wherein V_{dc} representing the input voltage of the bridge circuit, Vₒ representing the output voltage of the output load, n representing a turn ratio of the transformer, and round ( ) representing a rounding function to obtain x as an integer.

11. The operation method of claim 10, wherein the required output voltages of the bridge circuit in the level 1 to level m are corresponding to different ratios of the input voltage of the bridge circuit.

12. The operation method of claim 10, wherein the at least one circuit mode includes 2^{(m-1)} circuit modes,
wherein the PWM signals, for switches, between each of the at least one circuit mode are different, and each of the at least one circuit mode corresponding to a value of the required output voltage.

13. The operation method of claim 9, wherein the switching frequency is obtained by the controller according to an inductor ratio, a transformer turn ratio and a resonant frequency of the LLC resonant tank, the output voltage of the output load, the required output voltage of the bridge circuit, and a quality factor.

14. The operation method of claim 9, wherein the plurality of capacitor-switch modules include four serial-connected capacitor-switch modules, and each of the four serial-connected capacitor-switch modules includes a complementary pair of switches and one capacitor,
wherein a gate of each switch of the four serial-connected capacitor-switch modules is coupled to the controller to receive the PWM signals to balance voltages of the capacitors of the two serial-connected capacitor-switch modules.

15. The operation method of claim 9, wherein the plurality of capacitor-switch modules include two serial-connected capacitor-switch modules, and each of the two serial-connected capacitor-switch modules includes a complementary pair of switches and one capacitor,
wherein a gate of each switch of the two serial-connected capacitor-switch modules is coupled to the controller to receive the PMW signals to balance voltages of the capacitors of the two serial-connected capacitor-switch modules.

16. The operation method of claim 9, wherein the plurality of capacitor-switch modules include four capacitor-switch modules with midpoint clamps and flying capacitors, and each of the four capacitor-switch modules includes a complementary pair of switches and one capacitor,
wherein a gate of each switch of the four capacitor-switch modules is coupled to the controller to receive the PWM signals to balance voltages of the flying capacitors of the four capacitor-switch modules.
